(19) United States
(12) Patent Application Publication
(10) Pub. No.: US 2007/0152497 A1
(43) Pub. Date: Jul. 5, 2007

(54) WHEEL FRAME

(76) Inventor: YEN-JIUN LIN, Changhua County (TW)

Correspondence Address: BANGER SHIA, 204 CANYON CREEK, VICTORIA, TX, 77901, US

(21) Appl. No.: 11/306,609

(22) Filed: Jan. 4, 2006

(51) Int. Cl. B60B 1/02

(52) U.S. Cl. 301/55

(57) ABSTRACT

The present invention relates to an improve structure for a wheel frame with a supporting member, which sets up a supporting member with geometry shaped between each spoke. The supporting member is installed around the outer edge of the hub. One end of the respective spokes is positioned on the supporting member, and the other end is positioned on the rim. Thereby, the supporting intensity of the supporting member can be increased so as to avoid being deformed, and the wind resistance can be reduced when the bicycle is ridden.

### BACKGROUND OF THE INVENTION

1. Field of the Invention

The present invention relates to a wheel frame, and more particularly to improve structure for a wheel frame with a supporting member.

2. Description of the Prior Art

Bicycle is one of the transportation instruments for human being since bicycle is developed, and it is because riding bicycle is convenient, environment protective and it can exercise our bodies. Therefore, in order to make the riding safer and smoother, an auxiliary device is usually disposed on the bicycle to reduce the wind resistance. The conventional design is making different on the rim. However, as the wheel rim 1 of bicycle on the market shown in FIG. 1, a plurality of spokes 102 are orderly hooked on the flanges 101 formed on two sides of hub 10 to connect with a rim 1, so that the rim 1 will be stressed while the bicycle is ridden and achieve the propose of support. However, as the holding power of spokes 102 of the ordinary rim 1, the intensity of the structure is not enough. It is mainly because the length of the spokes 102 are very long, especially when the spokes 102 are fewer and the supporting points are too loose, the supporting intensity of the rim 1 will be even more inadequate, so that the resistance will be increased as the result while the bicycle is ridden. Thereby, it is laborious and dangerous.

The present invention has arisen to mitigate and/or obviate the afore-described disadvantages.

### SUMMARY OF THE INVENTION

The primary objective of the present invention is to provide a wheel frame with a supporting member thereof, which can increase the supporting intensity of the wheel frame so as to avoid being deformed and reduce the resistance.

Furthermore, the supporting member can be disposed between the spokes, which is geometry shaped with a hollow portion, so that the hollow portion thereof can be deposed around the outer edge of the hub, and the plurality of auxiliary spokes are connected with the supporting member and fastened on the wheel rim.

The present invention will become more obvious from the following description when taken in connection with the accompanying drawings, which show, for purpose of illustrations only, the preferred embodiments in accordance with the present invention.

### BRIEF DESCRIPTION OF THE DRAWINGS

FIG. 1 is a side view of a conventional wheel frame;

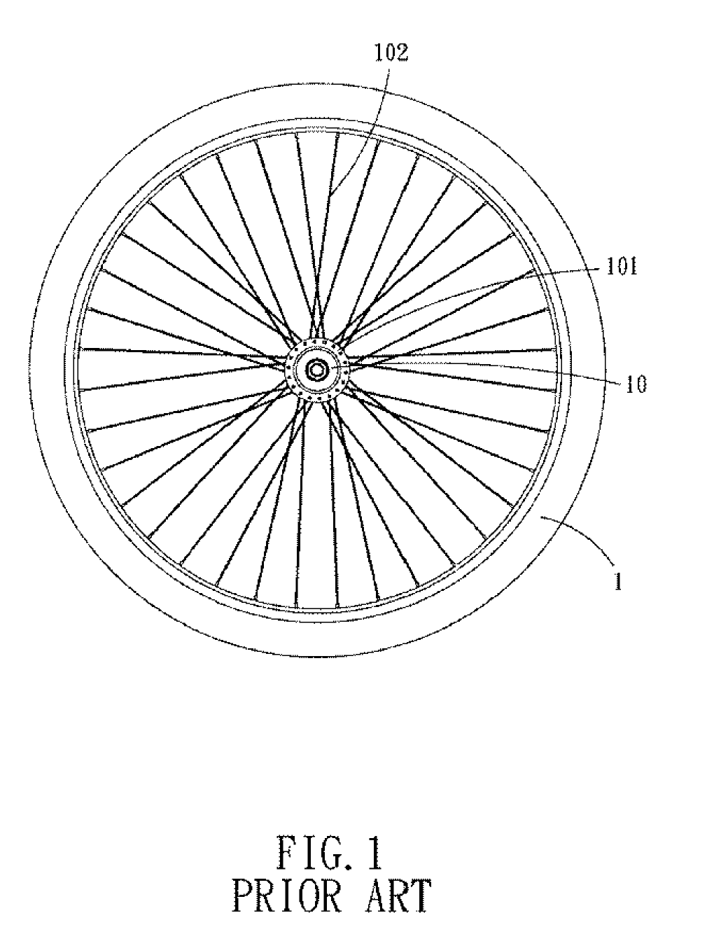

FIG. 2 is a side view of showing a wheel frame in accordance with the present invention;

FIG. 3 is a side view of the wheel frame in accordance with the present invention;

FIG. 4 is a perspective view of the wheel frame in accordance with the present invention;

FIG. 5 is a cross sectional view of the wheel frame in accordance with the present invention;

FIG. 6 is a side view of showing a pentagon supporting member of the wheel frame in accordance with the present invention; and

FIG. 7 is a side view of showing a triangle supporting member of the wheel frame in accordance with the present invention.

### DETAILED DESCRIPTION OF THE PREFERRED EMBODIMENTS

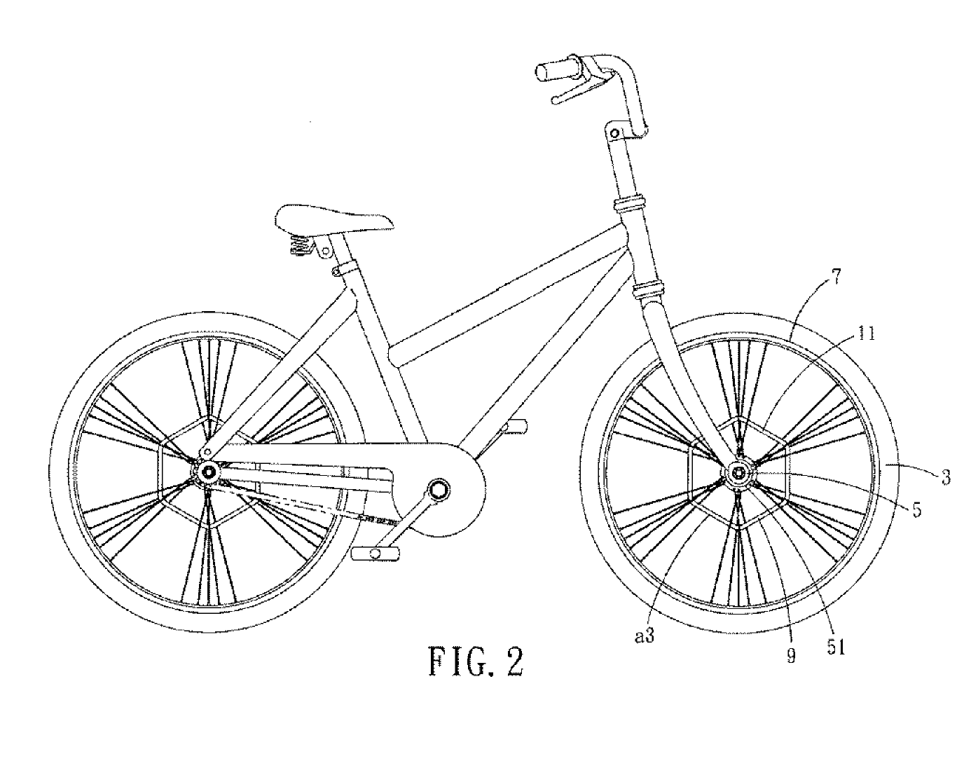

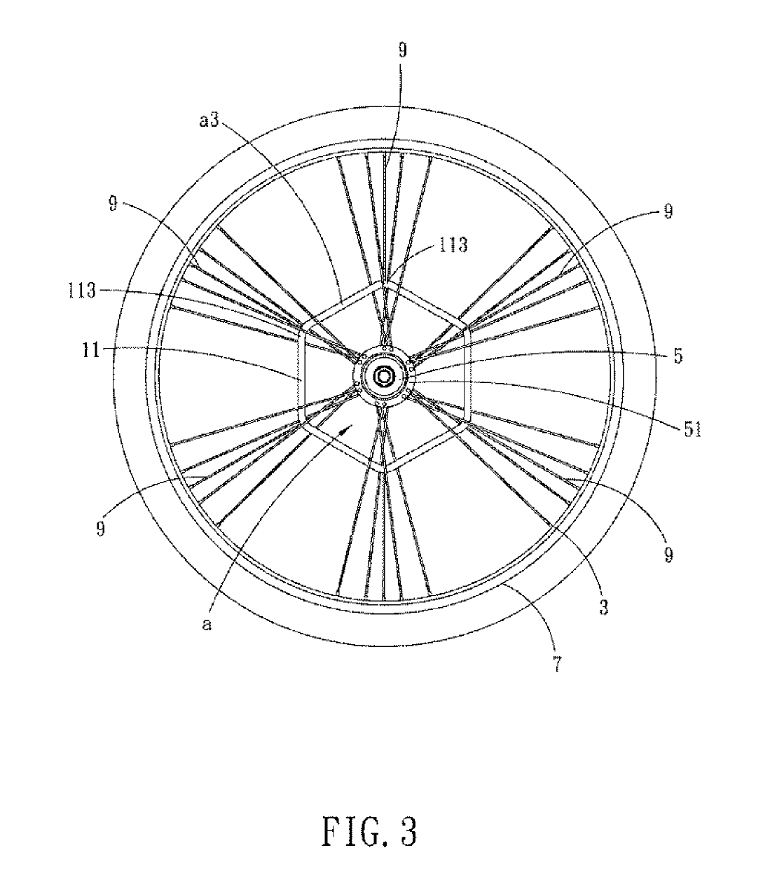

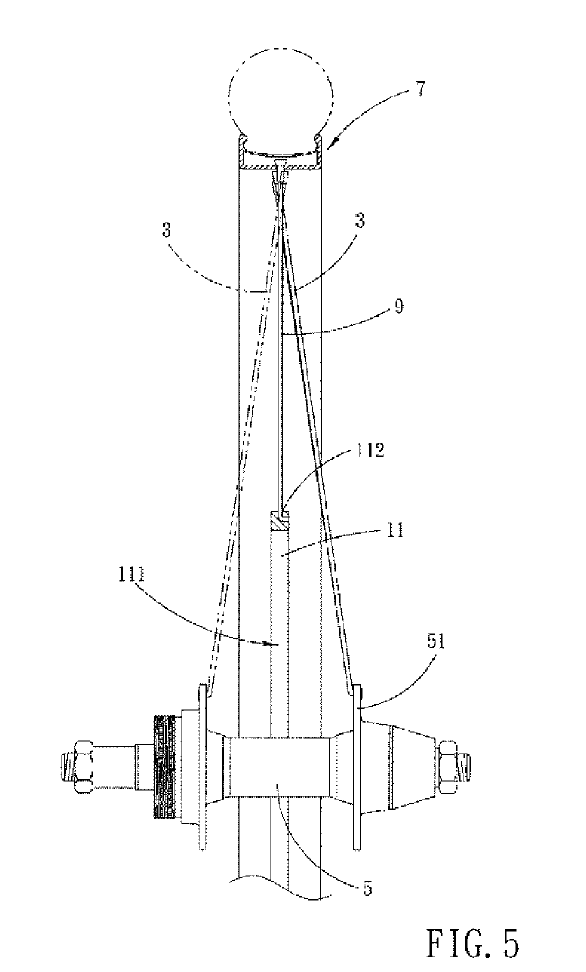

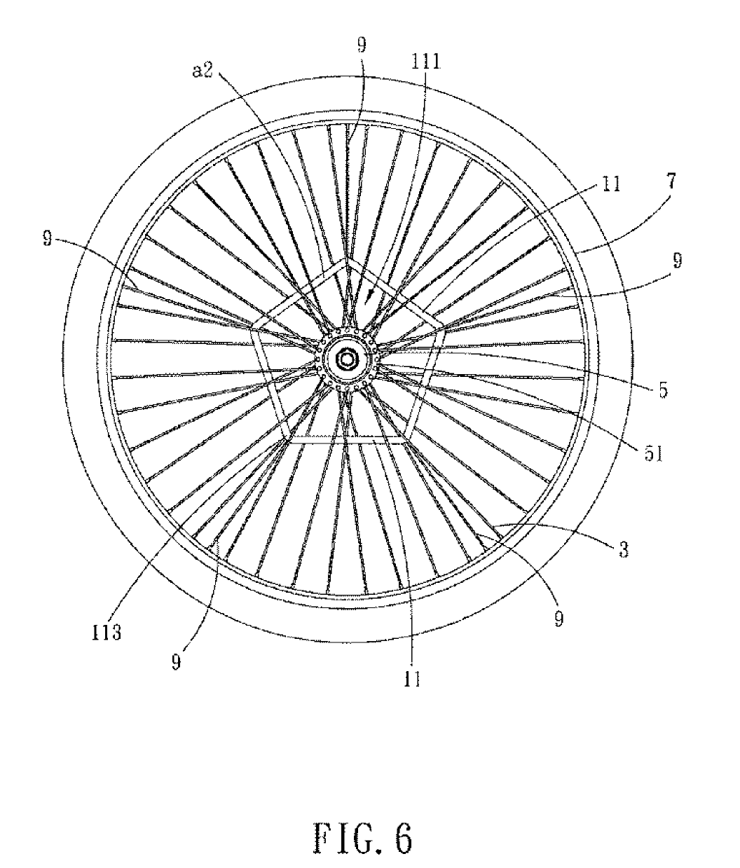

The present invention is composed by a plurality of spokes 3 and a hub 5, wherein one end of the respective spokes 3 is hooked on a flange 51 of the hub 5, the other end is connected with a rim 7. The present invention includes the plurality of auxiliary spokes 9 and a supporting member 11 as shown in FIGS. 2-6, wherein:

The supporting member 11 is formed between the spokes 3, which is geometry shaped with a hollow portion 111, so that the hollow portion 111 thereof can be deposed around the outer edge of the hub 5. Then, the plurality of auxiliary spokes 9 are connected with the supporting member 11 and mounted on the rim 7. Plurality of through holes 112 are orderly formed on the peripheral of the supporting member 11 so as to one end of the respective auxiliary spokes 9 can be passed through the through holes 112 and engaged with the supporting member 11 by hooking the through holes 112.

Referring to FIGS. 2-5, one end of the respective spokes 3 is hooked in the flange 51 of the hub 5, the other end is connected with the rim 7, and the spokes 3 are crossly arranged on the rim 7. The supporting member 11 which is formed between the rim 7 and the hub 5 is connected with the rim 7, the plurality of auxiliary spokes 9 are connected with the supporting member 11 and mounted on the rim 7. Plurality of through holes 112 are equidistantly formed on the peripheral of the supporting member 11 so that one end of the respective auxiliary spokes 9 can be passed through the through holes 112 and engaged with the supporting member 11 by hooking the through holes 112. The auxiliary spokes 9 are located between the crossly arranged spokes 3 of the rim 7, which means that the spokes 3 are crossed arranged surrounding the inner side of the rim 7 in the order of spoke 3, spoke 9, spoke 3. By such arrangement, when the user rides the bicycle, the rim 7 would disperse equally the support when the rim 7 is stressed, and the wind resistance can be reduced accordingly.

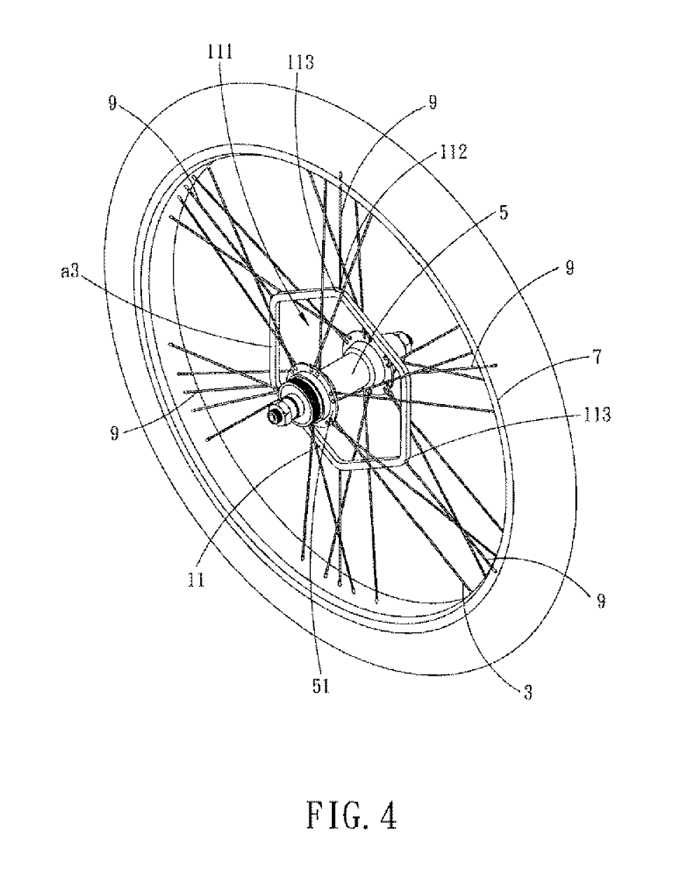

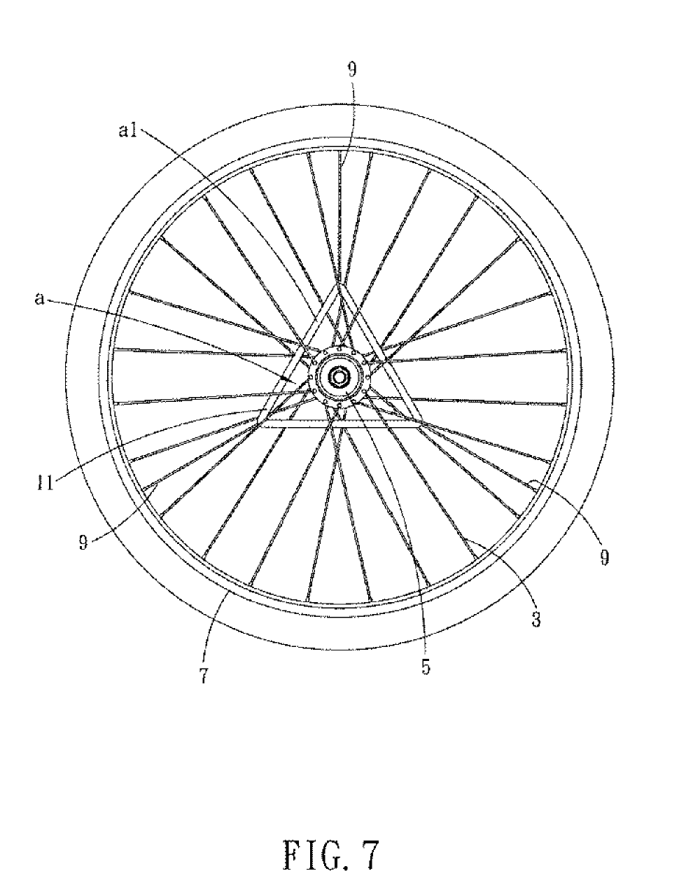

It is noted that as shown in FIGS. 4-7, the hollow portion 111 of the supporting member 11 is a hexagon a3, a pentagon a2 or a triangle al (analogy as follows). For equally dispersing the stress from the rim 7 when the rim 7 is stressed, the auxiliary spokes 9 are hooked and engaged on the bending potions 11 3 of the supporting member 11 to reduce the wind resistance.

While we have shown and described various embodiments in accordance with the present invention, it should be clear to those skilled in the art that further embodiments may be made without departing from the scope of the present invention.

What is claimed is:

1. A wheel frame, which is using the plurality of spokes fabricated equidistantly between a hub and a rim, characterized in that:
a supporting member with a hollow portion in geometry shaped is formed between each of the spokes, and fabricated around the outer edge of the hub, and connected with plurality of auxiliary spokes so as to be fabricated in the rim.

2. The wheel frame as claimed in claim 1, wherein the plurality of through holes are defined in the peripheral of the supporting member, which are equidistantly formed on the peripheral of the supporting member so that one end of the respective auxiliary spokes can be passed through the through holes and engaged by hooking the through holes.

3. The wheel frame as claimed in claim 1, wherein the hollow portion of the supporting member is a hexagon.

4. The wheel frame as claimed in claim 1, wherein the hollow portion of the supporting member is a pentagon.

5. The wheel frame as claimed in claim 1, wherein the hollow portion of the supporting member is a triangle.
